(19) United States
(12) Patent Application Publication
(10) Pub. No.: US 2026/0168888 A1
(43) Pub. Date: Jun. 18, 2026

(54) APPARATUS FOR DIAGNOSING A POST-PROCESSING SYSTEM AND A METHOD THEREOF

(71) Applicants: HYUNDAI MOTOR COMPANY, Seoul (KR); KIA CORPORATION, Seoul (KR); AVL SOFTWARE AND FUNCTIONS GMBH, Regensburg (DE)

(72) Inventors: Kangjin Kim, Hwaseong-si (KR); Dong Hee Han, Hwaseong-si (KR); Jong Il Park, Hwaseong-si (KR); Jonghyeok Lee, Hwaseong-si (KR); Minkyu Park, Hwaseong-si (KR); Hyunjin Kang, Hwaseong-si (KR); Olivier Pioch, Regensburg (DE)

(73) Assignees: HYUNDAI MOTOR COMPANY, Seoul (KR); KIA CORPORATION, Seoul (KR); AVL SOFTWARE AND FUNCTIONS GMBH, Regensburg (DE)

(21) Appl. No.: 19/270,944

(22) Filed: Jul. 16, 2025

(30) Foreign Application Priority Data
Dec. 12, 2024 (KR) 10-2024-0185059

(51) Int. Cl. G01M 15/10

(52) U.S. Cl. CPC G01M 15/102

(57) ABSTRACT

An apparatus for diagnosing a post-processing system includes: a first catalyst, an exhaust heat recovery system, and a second catalyst sequentially disposed on an exhaust line; a main bypass line branched from the exhaust line between the first catalyst and the recovery system and joining to the exhaust line downstream of the second catalyst; an auxiliary bypass line branched from the exhaust line between the first catalyst and the exhaust heat recovery system and joining to the exhaust line between the recovery system and the second catalyst; a first bypass valve disposed where the exhaust line and the main bypass line join; a second bypass valve disposed where the exhaust line and the auxiliary bypass line join; and a controller for diagnosing, when a diagnosis condition is satisfied, whether the first bypass valve is abnormal based on a temperature of an exhaust gas upstream of the exhaust heat recovery system.

### CROSS-REFERENCE TO RELATED APPLICATION

This application claims priority to and the benefit of Korean Patent Application No. 10-2024-0185059 filed with the Korean Intellectual Property Office on Dec. 12, 2024, the entire contents of which is incorporated herein by reference.

### BACKGROUND OF THE DISCLOSURE

### (a) Technical Field

The present disclosure relates to an apparatus for diagnosing a post-processing system and a method thereof, and more particularly, relates to an apparatus and method capable of diagnosing whether a valve disposed in a post-processing system is faulty.

### (b) Description of the Related Art

Recently, there is a trend in which the number of traditional internal combustion engine vehicles being produced is decreasing and the number of electric vehicles or hybrid vehicles with low exhaust emission is increasing. This trend is occurring at least partly in view of global exhaust emission regulations.

Among these low emission vehicles, the hybrid vehicle is a vehicle using two or more power sources such as engines and drive motors.

Since these hybrid vehicles have a drive motor that assists the engine's power, the engines used in hybrid vehicles are mostly operated at the highest thermal efficiency operating point or optimum operating point. When low-temperature combustion is achieved using a lean burn combustion mode at the highest thermal efficiency operating point, the combustion temperature is lowered. This increases the specific heat ratio and improves the efficiency of the hybrid vehicle.

Meanwhile, in accordance with emission regulations, vehicles are equipped with catalytic converters that purify various harmful substances contained in exhaust gases.

Typically, a three-way catalyst (TWC) reduces carbon monoxide (CO), hydrocarbons (HC), and nitrogen oxides (NOx) in the exhaust gas of a gasoline engine. The three-way catalyst is activated above a certain temperature, converting CO and HC into harmless components through oxidation reactions and NOx into harmless components through reduction reactions. These three-way catalysts have high thermal efficiency and low nitrogen oxide emission characteristics when the engine is operated in a theoretical air-fuel ratio mode.

However, when the engine is operated in the lean burn mode, the nitrogen oxide purification efficiency of the three-way catalyst deteriorates rapidly. Although the nitrogen oxide emissions are low when the engine is operated in a lean burn mode, the nitrogen oxide emissions increase because the purification efficiency of the three-way catalyst is very low.

Due to these problems, additional catalytic converters such as lean NOx trap (LNT) and/or selective catalytic reduction (SCR) are used to reduce exhaust gases containing nitrogen oxides in engines that apply a lean burn mode.

LNT absorbs nitrogen oxides that are not purified by the three-way catalyst under lean operating conditions. Also, LNT reduces absorbed nitrogen oxides to nitrogen (N₂) and releases them under rich operating conditions.

SCR is a catalyst that purifies ammonia (NH3) and nitrogen oxides into nitrogen and water by reacting them on a catalyst. Although the method of injecting urea solution to supply ammonia is widely used, a method of purifying nitrogen oxides without urea by using NH3 generated from LNT in conjunction with LNT (e.g. passive SCR) is also being used.

However, LNT's nitrogen oxide purification efficiency varies greatly depending on the temperature of the catalyst, and generally shows the highest purification efficiency between 250 and 350 degrees Celsius. On the other hand, at high temperatures (e.g., above 450 degrees Celsius), LNT catalysts are vulnerable, so nitrogen oxides are released without being reduced.

For gasoline engines, the exhaust gas temperature exceeds 900 degrees Celsius under full-load operating conditions. This deteriorates the purification efficiency of the LNT, but it is necessary to maintain the temperature of the LNT at an appropriate level in a lean burn mode.

Therefore, post-processing systems suitable for lean burn engines are being developed. These post-processing systems are equipped with various precision parts, and a method is required to diagnose whether the various parts are operating normally while the post-processing system is in operation.

The subject matter described in this section is intended to enhance the understanding of the background of the disclosure, and may include subject matter that is not already known to those of ordinary skill in the art to which the present technology belongs.

### SUMMARY OF THE DISCLOSURE

The present disclosure provides an apparatus for diagnosing a post-processing system and provides a method thereof. The apparatus and method are capable of diagnosing whether a component part applied to a post-processing system of a lean burn engine is operating or performing abnormally.

An apparatus for diagnosing a post-processing system may include a first catalyst, an exhaust heat recovery system, and a second catalyst sequentially disposed on an exhaust line. The apparatus may include a main bypass line branched from the exhaust line between the first catalyst and the exhaust heat recovery system and joining or joined to the exhaust line on a downstream side, i.e., downstream of the second catalyst. The apparatus may further include an auxiliary bypass line branched from the exhaust line between the first catalyst and the exhaust heat recovery system and joining or joined to the exhaust line between the exhaust heat recovery system and the second catalyst. The apparatus may also include a first bypass valve installed at a location where the exhaust line and the main bypass line join and a second bypass valve installed at a location where the exhaust line and the auxiliary bypass line join. The apparatus may further include a controller configured to perform a diagnosis process for diagnosing, i.e., to diagnose whether the first bypass valve is operating abnormally, i.e., is abnormal or in an abnormal state, based on a temperature of an exhaust gas on an upstream side or upstream of the exhaust heat recovery system. The diagnosis may occur or be performed when a diagnosis condition is satisfied.

The diagnosis condition may include: an operation state of an engine; a temperature of the exhaust gas flowing through an exhaust line on the upstream side of the exhaust heat recovery system; whether the first bypass valve is open or closed; and/or whether the second catalyst is being regenerated.

The diagnosis condition may be satisfied when the engine is operated in a driving mode other than a lean burn mode, the temperature of the exhaust gas flowing through the exhaust line on the upstream side of the exhaust heat recovery system is higher than or equal to a predetermined temperature, the first bypass valve is opened, and the second catalyst is not being regenerated.

When the diagnosis condition is satisfied, the controller may be configured to apply a control signal to close the first bypass valve for a predetermined time and to determine whether the first bypass valve is operating abnormally by comparing the temperature of the exhaust gas on an upstream side of the first bypass valve at a time at which the control signal is applied with the temperature of the exhaust gas on the upstream side of the first bypass valve after the predetermined time has elapsed.

The controller may determine that the first bypass valve is operating normally when a difference between the temperature of the exhaust gas on the upstream side of the exhaust heat recovery system at the time at which the control signal is applied and the temperature of the exhaust gas on the upstream side of the exhaust heat recovery system after the predetermined time has elapsed is greater than or equal to a threshold temperature.

The controller may determine that the first bypass valve is stuck open when a difference between the temperature of the exhaust gas on the upstream side of the exhaust heat recovery system at the time point at which the control signal is applied and the temperature of the exhaust gas on the upstream side of the exhaust heat recovery system after the predetermined time has elapsed is lower than a threshold temperature.

The controller may be configured to terminate the diagnosis process, based on a release condition being satisfied.

The release condition may be satisfied when an engine is stopped, the second catalyst is being regenerated, the first bypass valve is determined to be operating abnormally, or the temperature of the exhaust gas on the upstream side of the first bypass valve after the predetermined time has elapsed is lower than the temperature of the exhaust gas on the upstream side of the first bypass valve at a time at which the diagnosis process is started.

A method for diagnosing a post-processing system may include determining whether a diagnosis condition of a first bypass valve, which is installed on a location where an exhaust line on which a first catalyst, an exhaust heat recovery system, and a second catalyst are sequentially disposed, and a main bypass line connecting the exhaust lines on a downstream side of the first catalyst and on a downstream side of the second catalyst are joined, is satisfied. The method may also include, based on the diagnosis condition being satisfied, performing a diagnosis process for diagnosing, i.e., diagnosing, whether the first bypass valve is operating abnormally based on a temperature of an exhaust gas on an upstream side of the exhaust heat recovery system.

The diagnosis condition may be satisfied when an engine is operated in a driving mode other than a lean burn mode, a temperature of the exhaust gas flowing through an exhaust line on the upstream side of the exhaust heat recovery system is higher than or equal to a predetermined temperature, the first bypass valve is opened, and the second catalyst is not being regenerated.

The diagnosis process may include applying a control signal to close the first bypass valve for a predetermined time and determining whether the first bypass valve is operating abnormally by comparing a threshold temperature to a difference between the temperature of the exhaust gas on an upstream side of the first bypass valve at a time at which the control signal is applied and the temperature of the exhaust gas on the upstream side of the first bypass after the predetermined time has elapsed.

The first bypass valve may be determined to be operating normally when the difference between the temperature of the exhaust gas on the upstream side of the first bypass valve at the time at which the control signal is applied and the temperature of the exhaust gas on the upstream side of the first bypass after the predetermined time has elapsed is greater than or equal to the threshold temperature.

The first bypass valve may be determined to be stuck open when the difference between the temperature of the exhaust gas on the upstream side of the first bypass valve at the time at which the control signal is applied and the temperature of the exhaust gas on the upstream side of the first bypass after the predetermined time has elapsed is less than the threshold temperature.

The method may further include, when the release condition is satisfied, determining whether a release condition for terminating the diagnosis process of the first bypass valve is satisfied and terminating the diagnosis process.

The release condition may be satisfied when an engine is stopped, the second catalyst is being regenerated, the first bypass valve is determined to be operating abnormally, or the temperature of the exhaust gas on the upstream side of the first bypass valve after the predetermined time has elapsed is lower than the temperature of the exhaust gas on the upstream side of the first bypass valve at a time at which the diagnosis process is started.

According to an embodiment, whether the first bypass valve is stuck open can be accurately diagnosed based on the exhaust gas temperature on the upstream side of the exhaust heat recovery system.

Other effects that may be obtained by or that may be predictable from an embodiment are explicitly or implicitly described in the detailed description of the present disclosure. That is to say, various effects that are predictable according to an embodiment of the present disclosure are described in the following detailed description.

### BRIEF DESCRIPTION OF THE DRAWINGS

The accompanying drawings are for reference in describing embodiments of the present disclosure. The technical spirit of the present disclosure should not be construed as being limited to the accompanying drawings.

FIG. 1 is a schematic view showing a configuration of a vehicle to which a post-processing system according to an embodiment of the present disclosure is applied.

FIG. 2 is a block diagram showing a configuration of a post-processing system according to an embodiment of the present disclosure.

FIGS. 3-5 are operation diagrams for describing an operation of a post-processing system according to an embodiment of the present disclosure.

FIG. 6 is a flowchart showing a method for diagnosing a post-processing system according to an embodiment of the present disclosure.

FIGS. 7 and 8 are graphs for describing a method for diagnosing a post-processing system according to an embodiment of the present disclosure.

FIG. 9 is a diagram of a computing device according to an embodiment of the present disclosure.

It should be understood that the above-referenced drawings are not necessarily drawn to scale, presenting a somewhat simplified representation of various features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

The terminology used herein is for the purpose of describing particular embodiments only and is not intended to be limiting of the present disclosure. As used herein, the singular forms are intended to include the plural forms as well, unless the context clearly indicates otherwise. It should be further understood that the terms “comprises” and/or “comprising,” “includes” and/or “including,” “has” and/or “having,” and variations thereof, when used in this specification, specify the presence of stated features, integers, steps, operations, elements, and/or components. Such terms do not preclude the presence or addition of one or more other features, integers, steps, operations, elements, components, and/or groups thereof. As used herein, the term “and/or” includes any one or all combinations of one or more related items.

Additionally, it should be understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes, which are described further below. The controller may control operation of units, modules, parts, devices, or the like, as described herein. Moreover, it should be understood that the below methods may be executed by an apparatus comprising the controller in conjunction with one or more other components, as should be appreciated by a person of ordinary skill in the art.

Furthermore, the controller of the present disclosure may be embodied as non-transitory computer readable media containing executable program instructions executed by a processor. Examples of the computer readable media include, but are not limited to, read-only memory (ROM), random-access memory (RAM), compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Features and aspects of the present disclosure are described more fully hereinafter with reference to the accompanying drawings, in which embodiments of the disclosure are illustrated. As those having ordinary skill in the art should realize, the described embodiments may be modified in various different ways, all without departing from the spirit or scope of the present disclosure.

The drawings and description are to be regarded as illustrative in nature and not restrictive. Like reference numerals designate like elements throughout the specification.

In addition, the size and thickness of each configuration shown in the drawings are arbitrarily shown for understanding and ease of description, but the present disclosure is not limited thereto. The thickness of layers, films, panels, regions, etc., may be exaggerated for clarity.

Suffixes, such as “module” and/or “unit,” for a constituent element used for the description below are merely for ease of description. The suffix itself does not have a discriminated meaning or role.

Further, in describing the embodiments set forth in the present disclosure, where it has been determined that detailed description relating to well-known functions or configurations may have made the subject matter of the embodiments disclosed in the present disclosure unnecessarily ambiguous, the detailed description has been omitted.

Further, the accompanying drawings are provided to help understand embodiments disclosed in the present specification. The technical spirit disclosed in the present specification is not limited by the accompanying drawings. It should be appreciated that the present disclosure includes all of the modifications, equivalent matters, and substitutes included in the spirit and the technical scope of the present disclosure.

Terms including ordinal numbers such as first, second, and the like may be used only to describe various components, and are not to be interpreted as limiting these components. The terms are only used to differentiate one component from others.

As used herein, the singular forms “a”, “an” and “the” are intended to include the plural forms as well, unless the context clearly indicates otherwise.

When a component, device, element, unit, module, controller, or the like of the present disclosure is described as having a purpose or performing an operation, function, or the like, the component, device, element, unit, module, or controller should be considered herein as being “configured to” meet that purpose or to perform that operation or function. The present disclosure describes a controller for a post-processing system. The controller may separately embody or be included with a processor and a memory, such as a non-transitory computer readable media, as part of the controller.

Hereinafter, a diagnosis apparatus of a post-processing system cooling apparatus according to embodiments of the present disclosure are described in detail with reference to the accompanying drawings.

First, a vehicle applied with a post-processing apparatus of an engine according to an embodiment is described in detail.

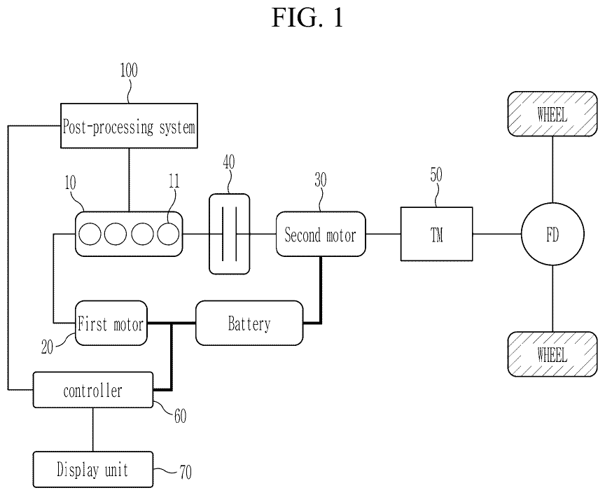

FIG. 1 is a schematic view showing a configuration of a vehicle to which a post-processing system according to an embodiment is applied.

As shown in FIG. 1, a vehicle applied with a post-processing system according to an embodiment may include an engine 10, a first motor 20, a second motor 30, a clutch 40, and a controller 60.

The engine 10 may include a plurality of cylinders 11 configured to generate the power required for driving the vehicle by combustion of fuel. In an embodiment, the engine 10 may be a gasoline engine 10.

The first motor 20 may start the engine 10, and as needed, may selectively operate as a generator, to generate electrical energy. The first motor 20 may be a kind of integrated starter-generator.

The second motor 30 may generate power required for driving the vehicle, and as needed, may assist the power of the engine 10. In addition, the second motor 30 may selectively operate as a generator, to generate electrical energy.

The clutch 40 may be provided between the engine 10 and the second motor 30. Depending on engagement of the clutch 40, the hybrid vehicle may drive in an electric vehicle (EV) mode or in a hybrid electric vehicle (HEV) mode.

The electric vehicle (EV) mode may be a mode in which the vehicle drives with only the power of the second motor 30. The hybrid electric vehicle (HEV) mode may be a mode in which the vehicle drives with the power of the engine 10 and the power of the second motor 30.

The power output from the engine 10 and the second motor 30 may be transferred to drive wheels provided on the vehicle. At this time, a transmission 50 may be provided between the clutch 40 and drive wheels.

Gears are installed inside the transmission 50, and depending on the shifting gears, the power output by the engine 10 and the second motor 30 may be changed.

The controller 60 may control the components of the hybrid vehicle, which includes the engine 10, the first motor 20, the second motor 30, the clutch 40, and a post-processing system 100 described further below.

In particular, the controller 60 may perform a diagnosis process for diagnosing whether the valves of the post-processing system 100 (e.g., a first bypass valve) are abnormal, i.e., operating abnormally or in an abnormal state. The diagnosis may be based on the temperature of an exhaust gas on an upstream side, i.e., upstream of the exhaust heat recovery system of the post-processing system 100.

To this end, the controller 60 may be provided as at least one processor including a predetermined program with executable instructions. The predetermined program is configured to instruct or control a diagnosis apparatus to perform respective steps of the post-processing system 100 according to an embodiment of the present disclosure.

Various hazardous substances contained in the exhaust gas discharged from the engine 10 may be purified through the post-processing system 100, and may be discharged to the air through a tail pipe, after attenuating its noise while passing through a muffler.

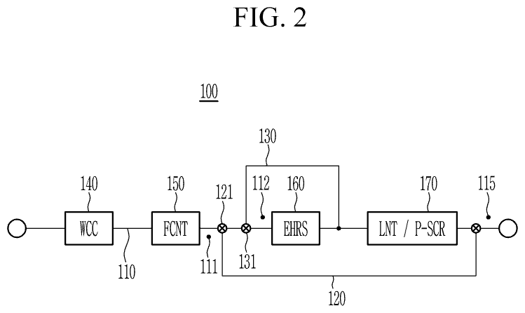

FIG. 2 is a block diagram showing a configuration of a post-processing system according to an embodiment.

Referring to FIG. 2, the post-processing system 100 according to an embodiment may include a warming-up catalytic converter (WCC) catalyst 140, a fuel cut NOx trap (FCNT) catalyst 150, and a lean NOx trap (LNT) catalyst 170, sequentially disposed along an exhaust line 110.

The WCC catalyst 140, the FCNT catalyst 150, and the LNT catalyst 170 may purify the hazardous substances included in the exhaust gas discharged through the exhaust line 110. The WCC catalyst 140, the FCNT catalyst 150, and the LNT catalyst 170 may be sequentially disposed along the flow direction of the exhaust gas flowing through the exhaust line 110.

An exhaust heat recovery system (EHRS) 160 may be disposed on the exhaust line 110 between the FCNT catalyst 150 and the LNT catalyst 170. The exhaust heat recovery system 160 may be a type of heat-exchanger, and may recollect the heat included in the exhaust gas discharged from the combustion chamber of the engine through the operation fluid (e.g., coolant).

A lambda sensor 115 may be provided on the exhaust line 110. Through an oxygen concentration of the exhaust gas measured through the lambda sensor 115, the controller 60 may determine an air/fuel ratio (AFR) of the engine.

A plurality of bypass lines 120 and 130 detouring, i.e. bypassing, rerouting or redirecting, the exhaust heat recovery system 160 and the LNT catalyst 170 may be provided on the exhaust line 110 along which the exhaust gas discharged from the engine 10 flows. The plurality of bypass lines may include a main bypass line 120 and an auxiliary bypass line 130.

The main bypass line 120 may be branched from the exhaust line 110 between the FCNT catalyst 150 and the exhaust heat recovery system 160, and may rejoin, i.e., be rejoined to the exhaust line 110 on a downstream side, i.e., downstream of the LNT catalyst 170. A first bypass valve 121 may be installed at a location where the exhaust line 110 and the main bypass line 120 are rejoined. The first bypass valve 121 may be implemented as a 3-way valve.

Depending on the opening and closing of the first bypass valve 121 operated by the controller 60, the exhaust gas having passed through the WCC catalyst 140 and the FCNT catalyst 150 may pass through the LNT catalyst 170 disposed on the exhaust line 110, or may selectively flow through the main bypass line 120 bypassing the LNT catalyst 170. In other words, depending on the opening and closing of the first bypass valve 121, the exhaust gas may pass through or bypass the LNT catalyst 170.

The auxiliary bypass line 130 may be branched from the exhaust line 110 between the FCNT catalyst 150 and the exhaust heat recovery system 160, and may rejoin, i.e., be rejoined to the exhaust line 110 between the exhaust heat recovery system 160 and the LNT catalyst 170. A second bypass valve 131 may be installed at a location where the exhaust line 110 and the auxiliary bypass line 130 are rejoin. The second bypass valve may be implemented as a 3-way linear valve (3-way linear valve).

Depending on the opening and closing of the second bypass valve 131 operated by the controller 60, the exhaust gas having passed through the WCC catalyst 140 and the FCNT catalyst 150 may pass through the exhaust heat recovery system 160 installed on the exhaust line, or may selectively flow through the auxiliary bypass line 130 bypassing the exhaust heat recovery system 160. In other words, depending on the opening and closing of the second bypass valve 131, the exhaust gas may pass through or bypass the exhaust heat recovery system 160.

In an embodiment, the controller 60 may control the operation of the first bypass valve 121 and the second bypass valve 131, to change a discharge path of the exhaust gas. In other words, according to an operation of the first bypass valve 121 and the second bypass valve 131, the discharge path of the exhaust gas may be selectively determined as any one of a first discharge path to a third discharge path.

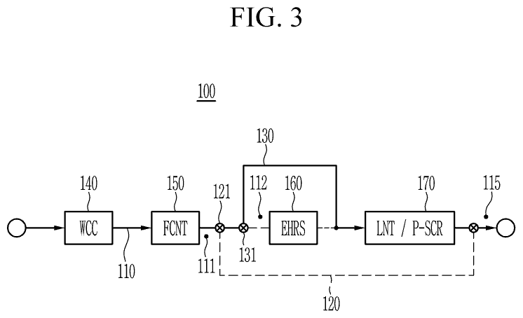

When the controller 60 opens the first bypass valve 121 and opens the second bypass valve 131, the exhaust gas having passed through the WCC catalyst 140 and the FCNT catalyst 150 may bypass the exhaust heat recovery system 160, pass through the LNT catalyst 170, and then be discharged to the air through the muffler. In an embodiment, such a path of the exhaust gas may be referred to as the first discharge path (see FIG. 3). The first discharge path may be used in a warm-up mode for heating the LNT catalyst 170.

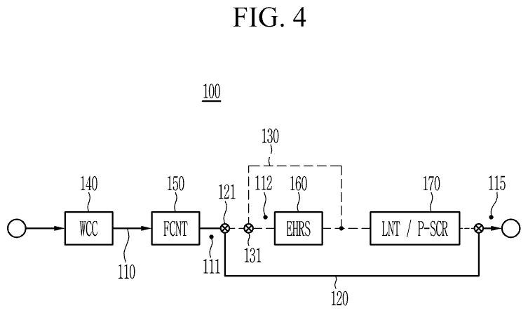

When the controller 60 blocks or closes the first bypass valve 121 and opens the second bypass valve 131, the exhaust gas having passed through the WCC catalyst 140 and the FCNT catalyst 150 may bypass the exhaust heat recovery system 160 and the LNT catalyst 170, and then may be discharged to the air through the muffler. In an embodiment, such a path of the exhaust gas may be referred to as a second discharge path (see FIG. 4). The second discharge path may be used when the engine operates in a theoretical air/fuel ratio area.

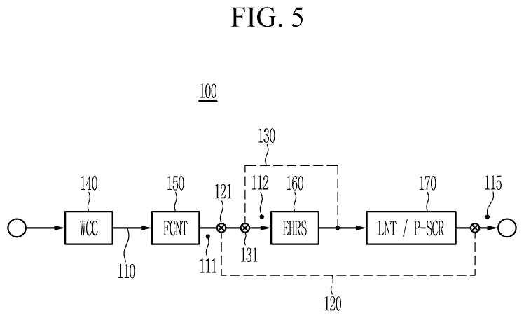

When the controller 60 opens the first bypass valve 121 and blocks closes the second bypass valve 131, the exhaust gas having passed through the WCC catalyst 140 and the FCNT catalyst 150 may pass through the exhaust heat recovery system 160 and the LNT catalyst 170, and then may be discharged to the air through the muffler. In an embodiment of the present disclosure, such a path of the exhaust gas is referred to as the third discharge path (see FIG. 5). The third discharge path may be used to recollect the exhaust heat through the exhaust heat recovery system 160, when the LNT catalyst 170 is overheated by the high-temperature exhaust gas.

A post-processing system 100 according to an embodiment may include a first temperature sensor 111 configured to measure the temperature of the exhaust gas flowing through the exhaust line 110 on an upstream side of the first bypass valve 121. The post-processing system 100 may also include a second temperature sensor 112 configured to measure the temperature of the exhaust gas flowing through the exhaust line 110 on an upstream side of the exhaust heat recovery system 160.

That is to say, the first temperature sensor 111 may be installed on the exhaust line 110 on the upstream side of the first bypass valve 121 and may measure the temperature of the exhaust gas flowing through the exhaust line 110 on the upstream side of the first bypass valve 121. The temperature of the exhaust gas measured by the first temperature sensor 111 may be transmitted to the controller 60.

The second temperature sensor 112 may be installed on an exhaust line 100 on the upstream side of the exhaust heat recovery system 160 and may measure the temperature of the exhaust gas flowing through the exhaust line 100 on the upstream side of the exhaust heat recovery system 160. The temperature of the exhaust gas measured by the second temperature sensor 112 may be transmitted to the controller 60.

When a diagnosis condition is satisfied, the controller 60 may determine whether the first bypass valve 121 is operating abnormally based on the temperature of the exhaust gas measured by the first temperature sensor 111 and the temperature of the exhaust gas measured by the second temperature sensor 112. The controller 60 may display whether the first bypass valve 121 is normal and/or abnormal, through a display unit 70.

In other words, when the diagnosis condition is satisfied, the controller 60 may apply a control signal to momentarily block or close the first bypass valve 121 and then reopen it while the first bypass valve 121 is open. At this time, the controller 60 may determine whether the first bypass valve 121 is stuck open, through the temperature change of the exhaust gas measured by the first temperature sensor 111 and the second temperature sensor 112.

The diagnosis condition for determining whether the first bypass valve 121 is operating abnormally may include various conditions. These conditions may include: an operation state of the engine; the temperature of the exhaust gas flowing through the exhaust line 110 on the upstream side of the exhaust heat recovery system 160 (e.g., the temperature of the exhaust gas measured by the first temperature sensor 111); whether the first bypass valve 121 is open or closed; and/or whether the LNT catalyst 170 is being regenerated.

In an embodiment, the diagnosis condition may be satisfied based on whether or when: the engine is operating or being operated in a driving mode other than a lean burn mode; the temperature of the exhaust gas flowing through the exhaust line 110 on the upstream side of the exhaust heat recovery system 160 is higher than or equal to a predetermined temperature; the first bypass valve 121 is open; and the LNT catalyst 170 is not being regenerated.

When the engine is being driven in the lean burn mode, the exhaust gas must pass through the LNT catalyst 170 since nitrogen oxide (NOx) emissions are high. While the engine is operating or being operated in a lean burn mode, when the first bypass valve 121 is momentarily blocked or closed to diagnose whether the first bypass valve 121 is abnormal, the exhaust gas bypasses the LNT catalyst 170, which increases the nitrogen oxide emissions. Therefore, when the engine is operating in the lean burn mode, the exhaust gas must always be supplied to the LNT catalyst 170, and the controller 60 does not diagnose whether the first bypass valve 121 is operating abnormally. A driving mode other than the lean burn mode may be determined based on the air/fuel ratio (AFR). When the air/fuel ratio is smaller than 1.5, it may be determined that it is not a lean burn mode.

When the LNT catalyst 170 is being regenerated, the engine may be operated in a rich condition, and the emission of hazardous substances such as carbon dioxide may increase. Therefore, since the engine is operated in a rich state for regeneration of the LNT catalyst 170, the exhaust gas should not bypass the LNT catalyst 170. In addition, when the first bypass valve 121 is temporarily closed in order to diagnose whether the first bypass valve 121 is operating abnormally, the LNT catalyst 170 is not regenerated. Therefore, when the LNT catalyst 170 is being regenerated, the controller 60 does not diagnose whether the first bypass valve 121 is operating abnormally.

The reason of determining whether the temperature of the exhaust gas flowing through an exhaust line 110 on the upstream side of the exhaust heat recovery system 160 is higher than or equal to the predetermined temperature (e.g., 300 degrees Celsius) is to determine whether the engine is sufficiently warmed-up.

Since whether the first bypass valve 121 is operating abnormally is diagnosed based on whether the first bypass valve 121 is stuck open, the controller 60 may determine whether the first bypass valve 121 is open.

Hereinafter, a method for diagnosing a post-processing system according to an embodiment is described in detail with reference to the drawings.

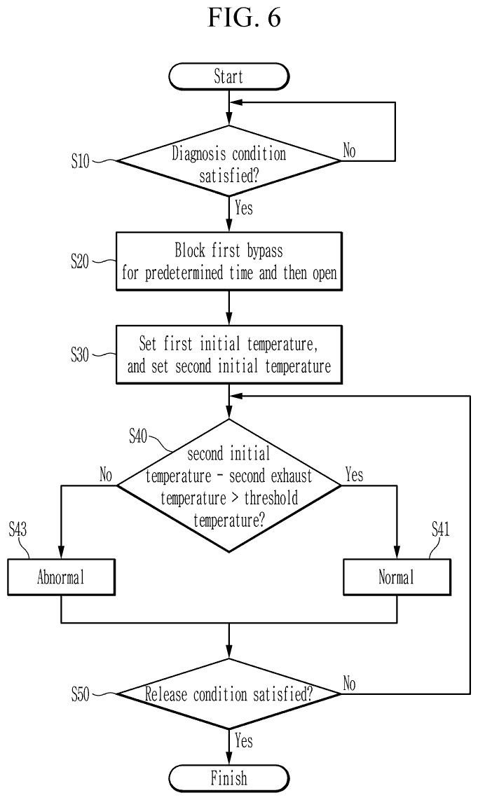

FIG. 6 is a flowchart showing a method for diagnosing a post-processing system according to an embodiment.

Referring to FIG. 6, the controller 60 may determine whether the diagnosis condition is satisfied, at step S10. The diagnosis condition is the same as described above, and a detailed description thereof is not included herein.

When the diagnosis condition is satisfied (YES at step S10), the diagnosis flag may be turned on, and the controller 60 may perform the diagnosis process for determining whether the first bypass valve 121 is operating abnormally.

In other words, when the diagnosis condition is satisfied, the diagnosis flag may be turned on, and the controller 60 may apply a control signal to temporarily block or close the first bypass valve 121 for a predetermined time (e.g., 1 second) and then open it, at step S20.

Simultaneously, the controller 60 may set the temperature of the exhaust gas on the upstream side of the first bypass valve 121 measured by the first temperature sensor 111 at a time at which the diagnosis flag is turned on (a time at which the control signal is applied to close the first bypass valve 121) as a first initial temperature, and may set the temperature of the exhaust gas on an upstream side of exhaust heat-exchange device 160 measured by the second temperature sensor 112 as a second initial temperature, at step S30.

Hereinafter, after the predetermined time has elapsed, the temperature of the exhaust gas on the upstream side of the first bypass valve 121 may be referred to as a first exhaust temperature, and the temperature of the exhaust gas on the upstream side of the exhaust heat recovery system 160 may be referred to as a second exhaust temperature.

The controller 60 may determine whether a difference between the second initial temperature and the temperature of the exhaust gas on the upstream side of the exhaust heat recovery system 160 after the predetermined time has elapsed (hereinafter, when appropriate, referred to as ‘the second exhaust temperature’) is greater than a threshold temperature (e.g., 10 degrees Celsius), at step S40.

At the step S40, when the second initial temperature is greater than the second exhaust temperature by the threshold temperature (YES at step S40), the controller 60 may determine that the first bypass valve 121 is operating normally, at step S41.

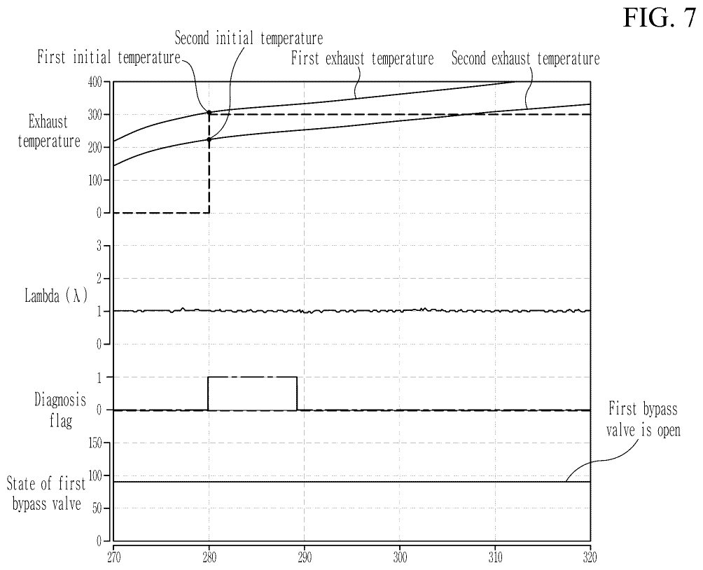

FIG. 7 is a graph obtained when the first bypass valve is operating in a normal state, i.e., operating normally.

Referring to FIG. 7, it may be seen that the temperature of the exhaust gas (first initial temperature) on the upstream side of the exhaust heat recovery system 160 at the time at which the diagnosis flag is turned on (a time at which the control signal is applied to close the first bypass valve 121 for the predetermined time) is about 300 degrees Celsius. In addition, it may be seen that, after the predetermined time has elapsed, the temperature of the exhaust gas on the upstream side of the exhaust heat recovery system 160 is about 290 degrees Celsius.

In such a case, as the first bypass valve 121 is closed by the control signal, the exhaust gas may not flow to the exhaust heat recovery system 160, and accordingly, the exhaust gas temperature on the upstream side of the exhaust heat recovery system 160 may be lowered. Therefore, it may be confirmed that the first bypass valve 121 normally operates.

At the step S40, when the difference between the second initial temperature and the second exhaust temperature is lower than or equal to the threshold temperature (NO at step 40), the controller 60 may determine the first bypass valve 121 to be operating abnormally, at step S43. When the first bypass valve 121 is determined to be operating abnormally, the controller 60 may notify the driver that the first bypass valve 121 is in an abnormal state, through the display unit 70.

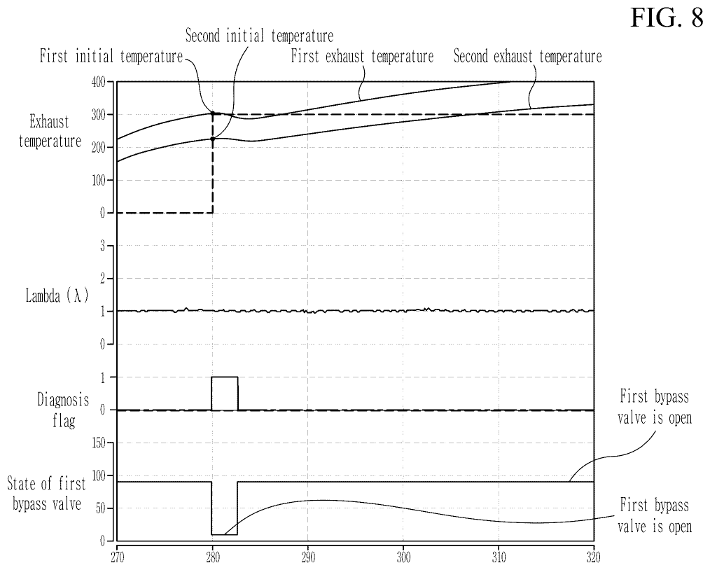

FIG. 8 is a graph showing that the first bypass valve is stuck open.

Referring to FIG. 8, it may be seen that the temperature of the exhaust gas (first initial temperature) on the upstream side of the exhaust heat recovery system 160 at the time at which the diagnosis flag is turned on (the time at which the control signal is applied to close the first bypass valve 121 for the predetermined time) is about 300 degrees Celsius. However, it may be seen that, after the predetermined time has elapsed, the temperature of the exhaust gas on the upstream side of the exhaust heat recovery system 160 is about 305 degrees Celsius.

It may be seen that the temperature of the exhaust gas on the upstream side of the exhaust heat recovery system 160 has increased even though a control signal to close the first bypass valve 121 for the predetermined time is applied. In such a case, the controller 60 may determine that the first bypass valve 121 is stuck open.

The controller 60 may determine whether a release condition, which is for terminating the diagnosis process for diagnosing whether the state of the first bypass valve 121 is abnormal, is satisfied, at step S50. If the release condition has not been satisfied (NO at step S50), the diagnosis process continues at step S40.

The release condition may be satisfied, when the engine may be stopped, or when the LNT catalyst 170 is being regenerated, or when the first bypass valve 121 is determined to be operating abnormally, or when the temperature of the first exhaust gas is lower than the first initial temperature.

The stoppage of the engine may mean that the vehicle is operated in the electric vehicle (EV) mode. When the engine is stopped as the vehicle is operated in the EV mode, the exhaust gas is not discharged from the engine, and the diagnosis of the first bypass valve 121 may not be smoothly performed.

Determining whether the LNT catalyst 170 is being regenerated is the same as described in connection with the diagnosis condition.

The temperature of the first exhaust gas may become lower than the first initial temperature when the engine load abruptly decreases, or due to an abnormal reason. In such a case, whether the first bypass valve 121 is operating abnormally may not be accurately determined based on the exhaust gas on the upstream side of the exhaust heat recovery system 160, the diagnosis of the first bypass valve 121 may not be normally performed.

When the release condition is satisfied (YES at step S50), the controller 60 terminates the diagnosis process of the first bypass valve 121, at step S60.

According to a diagnosis apparatus and method of a post-processing system according to embodiments described above, whether the first bypass valve 121 is operating abnormally (e.g., whether the first bypass valve 121 is stuck open) may be diagnosed based on the exhaust gas temperature of the upstream side of the exhaust heat recovery system 160 (the second initial temperature and the second exhaust temperature).

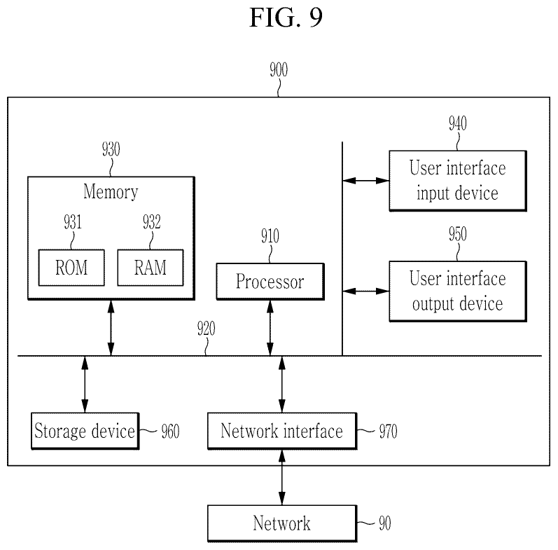

FIG. 9 is a diagram for explaining a computing device according to an embodiment.

Referring to FIG. 9, a method for diagnosing a post-processing system according to an embodiment may be implemented by using a computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 990. The network interface 970 may transmit or receive signals with other entities through the network 990.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 110 may be configured to implement the functions and methods in relation to FIGS. 1-8.

The memory 930 and the storage device 960 may include various types of volatile or non-volatile storage media. For example, the memory may include a read-only memory (ROM) 931 and a random access memory (RAM) 132. In this embodiment, the memory 930 may be located inside or outside processor 910, and the memory 930 may be connected to the processor 910 through various known means.

In some embodiments, at least some configurations or functions of the diagnosis apparatus of a post-processing system according to the embodiments described herein may be implemented by a program or software running on the computing device 900, and the program or software may be stored on a computer-readable medium.

In some embodiments, at least some components or functions of a vehicle mileage recognizing method and apparatus according to the embodiments described herein may be implemented using hardware or a circuit of the computing device 900 or may be implemented as separate hardware or a circuit that may be electrically connected to the computing device 900.

Although embodiments of the present disclosure have been described, the present disclosure is not limited thereto. It is possible to carry out various modifications within the scope of the claims, the detailed description of the disclosure, and the accompanying drawings, and the modifications are within to the scope of the present disclosure as a matter of course.

### DESCRIPTION OF SYMBOLS

10: Engine
11: Cylinder
20: First motor
30: Second motor
40: Clutch
50: Transmission
60: Controller
70: Display unit
100: Post-processing system
110: Exhaust line
111: First temperature sensor
112: Second temperature sensor
120: Main bypass line
121: First bypass valve
130: Auxiliary bypass line
131: Second bypass valve
140: WCC catalyst
150: FCNT catalyst
160: Exhaust heat recovery system
170: LNT catalyst

What is claimed is:

1. An apparatus for diagnosing a post-processing system, the apparatus comprising:
a first catalyst, an exhaust heat recovery system, and a second catalyst sequentially disposed on an exhaust line;
a main bypass line branched from the exhaust line between the first catalyst and the exhaust heat recovery system and joined to the exhaust line downstream of the second catalyst;
an auxiliary bypass line branched from the exhaust line between the first catalyst and the exhaust heat recovery system and joined to the exhaust line between the exhaust heat recovery system and the second catalyst;
a first bypass valve located where the exhaust line and the main bypass line are joined;
a second bypass valve located where the exhaust line and the auxiliary bypass line are joined; and
a controller configured to diagnose, based on a diagnosis condition being satisfied, whether the first bypass valve is operating abnormally based on a temperature of an exhaust gas upstream of the exhaust heat recovery system.

2. The apparatus of claim 1, wherein the diagnosis condition comprises an operation state of an engine, a temperature of the exhaust gas flowing through an exhaust line on the upstream side of the exhaust heat recovery system, whether the first bypass valve is open or closed, or whether the second catalyst is being regenerated.

3. The apparatus of claim 2, wherein the diagnosis condition is satisfied based on the engine being operated in a driving mode other than a lean burn mode, the temperature of the exhaust gas flowing through the exhaust line upstream of the exhaust heat recovery system being higher than or equal to a predetermined temperature, the first bypass valve being open, and the second catalyst is not being regenerated.

4. The apparatus of claim 1, wherein, based on the diagnosis condition being satisfied, the controller is configured to apply a control signal to close the first bypass valve for a predetermined time and configured to determine whether the first bypass valve is operating abnormally by comparing the temperature of the exhaust gas upstream of the first bypass valve at a time at which the control signal is applied with the temperature of the exhaust gas upstream of the first bypass valve after the predetermined time has elapsed.

5. The apparatus of claim 4, wherein the controller determines the first bypass valve to be operating normally based on a difference between the temperature of the exhaust gas upstream of the exhaust heat recovery system at the time at which the control signal is applied and the temperature of the exhaust gas upstream of the exhaust heat recovery system after the predetermined time has elapsed being greater than or equal to a threshold temperature.

6. The apparatus of claim 4, wherein the controller determines the first bypass valve to be stuck open based on a difference between the temperature of the exhaust gas upstream of the exhaust heat recovery system at the time at which the control signal is applied and the temperature of the exhaust gas upstream of the exhaust heat recovery system after the predetermined time has elapsed being lower than a threshold temperature.

7. The apparatus of claim 4, wherein the controller is configured to terminate the diagnosis process when a release condition is satisfied.

8. The apparatus of claim 7, wherein the release condition is satisfied based on:
an engine not being operated;
the second catalyst being regenerated;
the first bypass valve being determined to be operating abnormally; or
the temperature of the exhaust gas upstream of the first bypass valve after the predetermined time has elapsed is lower than the temperature of the exhaust gas upstream of the first bypass valve at a time at which the diagnosis process is started.

9. A method for diagnosing a post-processing system, the method comprising:
determining whether a diagnosis condition of a first bypass valve is satisfied, wherein the first bypass valve is located where an exhaust line, on which a first catalyst, an exhaust heat recovery system, and a second catalyst are sequentially disposed and a main bypass line, branching from the exhaust line downstream of the first catalyst and rejoined to the exhaust line downstream of the second catalyst are joined; and
based on the diagnosis condition being satisfied, diagnosing whether the first bypass valve is operating abnormally based on a temperature of an exhaust gas upstream of the exhaust heat recovery system.

10. The method of claim 9, wherein the diagnosis condition is satisfied based on an engine is being operated in a driving mode other than a lean burn mode, a temperature of the exhaust gas flowing through an exhaust line upstream of the exhaust heat recovery system being higher than or equal to a predetermined temperature, the first bypass valve being open, and the second catalyst not being regenerated.

11. The method of claim 9, wherein diagnosis comprises:
applying a control signal to close the first bypass valve for a predetermined time; and
determining whether the first bypass valve is operating abnormally by comparing a threshold temperature to a difference between the temperature of the exhaust gas upstream of the first bypass valve at a time at which the control signal is applied and the temperature of the exhaust gas upstream of the first bypass after the predetermined time has elapsed.

12. The method of claim 11, wherein the first bypass valve is determined to be operating normally based on the difference between the temperature of the exhaust gas upstream of the first bypass valve at the time at which the control signal is applied and the temperature of the exhaust gas upstream of the first bypass after the predetermined time has elapsed being greater than or equal to the threshold temperature.

13. The method of claim 11, wherein the first bypass valve is determined to be stuck open based on the difference between the temperature of the exhaust gas upstream of the first bypass valve at the time at which the control signal is applied and the temperature of the exhaust gas upstream of the first bypass after the predetermined time has elapsed being less than the threshold temperature.

14. The method of claim 11, further comprising:
determining whether a release condition for terminating the diagnosis process of the first bypass valve is satisfied; and
terminating the diagnosis process based on the release condition being satisfied.

15. The method of claim 14, wherein the release condition is satisfied based on:
an engine not being operated;
the second catalyst being regenerated;
the first bypass valve being determined to be operating abnormally; or
the temperature of the exhaust gas upstream of the first bypass valve after the predetermined time has elapsed being lower than the temperature of the exhaust gas upstream of the first bypass valve at a time at which the diagnosis process is started.
